(19) United States
(12) Patent Application Publication
(10) Pub. No.: US 2022/0026571 A1
(43) Pub. Date: Jan. 27, 2022

(54) LIGHT DETECTION SYSTEM

(71) Applicant: CANON KABUSHIKI KAISHA, Tokyo (JP)

(72) Inventors: Daiki Shirahige, Kanagawa (JP); Hiroshi Sekine, Kanagawa (JP); Kazuhiro Morimoto, Kanagawa (JP)

(21) Appl. No.: 17/377,179

(22) Filed: Jul. 15, 2021

(30) Foreign Application Priority Data
Jul. 21, 2020 (JP) 2020-124549

(51) Int. Cl. G01S 17/42; G01S 7/481; G01S 7/484

(52) U.S. Cl. CPC G01S 17/42; G01S 7/484; G01S 7/4816; G01S 7/4814

(57) ABSTRACT

A light detection system includes a light detection unit including a plurality of photoelectric conversion portions and a calculation processing unit configured to execute calculation based on information acquired by the light detection unit, wherein the light detection unit acquires light amount distribution information of light based on an incident light beam incident on an object from a laser light source and light amount distribution information of light based on a reflected light beam reflected from the object in a two-dimensional plane, and the calculation processing unit calculates, from the light amount distribution information of light based on the incident light beam, the light amount distribution information of light, and time information, information about a normal vector with respect to a reflection plane of the object, and wherein the normal vector is a vector in three dimensions which includes a direction orthogonal to the two-dimensional plane.

### BACKGROUND

### Field

The aspect of the embodiments relates to a light detection system.

### Description of the Related Art

In light detection unit using an avalanche diode causing avalanche multiplication, there has been known a light detection unit which digitally measures the number of photons entering an avalanche diode to output a measured value as a digital signal from a pixel. This technique is called “Single-Photon Avalanche Diode (SPAD).

Japanese Patent Application Laid-Open No. 2018-088488 discusses an apparatus in which light emitted to an object from a light source device and reflected on a surface of the object is received by a light detection unit having a plurality of SPAD pixels, so that a distance image corresponding to a distance to the object can be acquired.

In the apparatus discussed in Japanese Patent Application Laid-Open No. 2018-088488, in order to acquire distance information, the light detection unit has to receive light reflected from the object. However, there is a case where the light detection unit cannot receive reflected light because of a shape of the object or a positional relationship between the object and the light detection unit. In this case, information about the object cannot be acquired by the apparatus discussed in Japanese Patent Application Laid-Open No. 2018-088488.

### SUMMARY

According to an aspect of the embodiments, a light detection system includes a light detection unit including a plurality of photoelectric conversion portions arranged in a two-dimensional plane, and a calculation processing unit configured to execute calculation based on information acquired by the light detection unit, wherein the light detection unit acquires light amount distribution information of light based on an incident light beam incident on an object from a laser light source and light amount distribution information of light based on a reflected light beam reflected on the object in the two-dimensional plane, wherein the calculation processing unit calculates, from the light amount distribution information of light based on the incident light beam, the light amount distribution information of light based on the reflected light beam, and time information about time at which the light amount distribution information of light based on the incident light beam and the light amount distribution information of light based on the reflected light beam are acquired, information about a normal vector with respect to a reflection plane of the object on which the incident light beam is reflected, and wherein the normal vector is a vector in three dimensions including a direction orthogonal to the two-dimensional plane.

According to another aspect of the embodiments, a light detection system includes a light detection unit including a plurality of photoelectric conversion portions arranged in a two-dimensional plane, and a calculation processing unit configured to execute calculation based on information acquired by the light detection unit, wherein the light detection unit acquires light amount distribution information of light based on an incident light beam incident on an object from a laser light source and light amount distribution information of light based on a refracting light beam refracted by the object in the two-dimensional plane, wherein the calculation processing unit calculates, from the light amount distribution information of light based on the incident light beam, the light amount distribution information of light based on the refracting light beam, and time information about time at which the light amount distribution information of light based on the incident light beam and the light amount distribution information of light based on the refracting light beam are acquired, information about a normal vector with respect to a refracting plane of the object by which the incident light beam is refracted, and wherein the normal vector is a vector in three dimensions including a direction orthogonal to the two-dimensional plane.

According to yet another aspect of the embodiments, a light detection system includes a light detection unit including a plurality of photoelectric conversion portions arranged in a two-dimensional plane, and a calculation processing unit configured to execute calculation based on information acquired by the light detection unit, wherein the light detection unit acquires light amount distribution information of light based on a reflected light beam emitted from a laser light source and reflected on an object in the two-dimensional plane, wherein the calculation processing unit calculates, from direction information of laser light emitted to the object from the laser light source, the light amount distribution information of light based on the reflected light beam, and time information about time at which the light amount distribution information of light based on the reflected light beam is acquired, information about a normal vector with respect to a reflection plane of the object on which the laser light is reflected, and wherein the normal vector is a vector in three dimensions which includes a direction orthogonal to the two-dimensional plane.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a light detection system according to a first exemplary embodiment.

FIGS. 2A and 2B are diagrams illustrating a general idea of the light detection system according to the first exemplary embodiment.

FIGS. 3A to 3E are diagrams illustrating an effect of the light detection system according to the first exemplary embodiment.

FIG. 4 is a configuration diagram illustrating a positional relationship between a light detection unit, a laser light source, and an object according to the first exemplary embodiment.

FIGS. 5A to 5F are diagrams and graphs illustrating a difference between a moving body traveling at speed slower than light speed and pulsed light traveling at light speed.

FIG. 6 is a configuration diagram of the light detection unit according to the first exemplary embodiment.

FIG. 7 is a diagram illustrating a driving pulse for the light detection unit according to the first exemplary embodiment.

FIG. 8 is a flowchart illustrating processing executed by a calculation processing unit according to the first exemplary embodiment.

FIG. 9 is a diagram illustrating a three-dimensional shape measurement result measured by the light detection system according to the first exemplary embodiment.

FIGS. 10A to 10D are diagrams and graphs illustrating a concept of calculation processing executed by the light detection system.

FIG. 11 is a configuration diagram illustrating a positional relationship between a light detection unit, a laser light source, and an object according to a second exemplary embodiment.

FIG. 12 is a configuration diagram illustrating a positional relationship between a light detection unit, a laser light source, and an object according to a third exemplary embodiment.

FIG. 13 is a configuration diagram illustrating a positional relationship between a light detection unit, a laser light source, and an object according to a fourth exemplary embodiment.

FIG. 14 is a configuration diagram illustrating a positional relationship between a light detection unit, a laser light source, and an object according to a fifth exemplary embodiment.

FIG. 15 is a configuration diagram illustrating a positional relationship between a light detection unit, a laser light source, and an object according to a sixth exemplary embodiment.

FIG. 16 is a configuration diagram illustrating a positional relationship between a light detection unit, a laser light source, and an object according to a seventh exemplary embodiment.

FIG. 17 is a configuration diagram illustrating a positional relationship between a light detection unit, a laser light source, and an object according to an eighth exemplary embodiment.

FIG. 18 is a configuration diagram illustrating a positional relationship between a light detection unit, a laser light source, and an object according to a ninth exemplary embodiment.

FIG. 19 is a configuration diagram illustrating a positional relationship between a light detection unit, a laser light source, and an object according to a tenth exemplary embodiment.

FIG. 20 is a configuration diagram illustrating a positional relationship between a light detection unit, a laser light source, and an object according to an eleventh exemplary embodiment.

FIG. 21 is a configuration diagram illustrating a positional relationship between a light detection unit, a laser light source, and an object according to a twelfth exemplary embodiment.

FIGS. 22A and 22B are configuration diagrams illustrating a positional relationship between a light detection unit, a laser light source, and an object according to a thirteenth exemplary embodiment.

### DESCRIPTION OF THE EMBODIMENTS

Embodiments described below are merely examples embodying a technical idea of the present disclosure, and are not intended to limit the present disclosure. In order to provide a clear description, sizes and a positional relationship of members in each of the drawings may be illustrated with exaggeration. In the below-described exemplary embodiments, the same reference numerals are applied to constituent elements similar to each other, and descriptions thereof will be omitted.

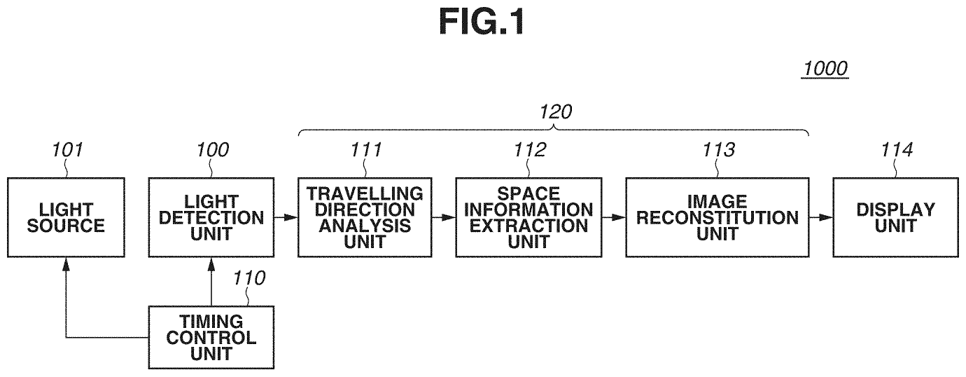

FIG. 1 is a block diagram illustrating a configuration of a light detection system 1000 according to a first exemplary embodiment.

A light source 101 is a laser light source capable of emitting laser light. For example, a short-pulse laser source such as a picosecond laser can be used as the light source 101. A wavelength of the light source 101 is not limited to a specific wavelength, and a light source that emits infrared light can also be used. For example, a light source having a peak wavelength of 750 nm and more to 1500 nm and less can be used.

A light detection unit 100 detects diffusion light generated from pulsed laser light emitted from the light source 101. The light detection unit 100 may detect pulsed laser light emitted from the light source 101. The light detection unit 100 is a single-photon avalanche diode (SPAD) array configured of a plurality of SPAD pixels arranged in the X-Y direction. Hereinafter, the light detection unit 100 including a photoelectric conversion portion configured of avalanche diodes will be described as an example. However, the present exemplary embodiment is not limited thereto, and the photoelectric conversion portion may be configured of photodiodes that does not cause avalanche multiplication.

A timing control unit 110 controls an light emission timing of the light source 101 and a light detection timing of the light detection unit 100. More specifically, the timing control unit 110 controls timings of starting and ending light emission executed by the light source 101 and timings of starting and ending light detection executed by the light detection unit 100. In other words, the timing control unit 110 synchronizes the light emission timing of the light source 101 and a light detection starting timing of the light detection unit 100. Herein, “synchronization” includes not only a state where the light emission timing of the light source 101 and the light detection starting timing are synchronized with each other, but also a state where the light emission and start of light detection are executed at different timings based on the control signal from the timing control unit 110. In other words, “synchronization” refers to a state where a timing at which light is emitted from the light source 101 and a timing at which the light detection unit 100 starts executing light detection are controlled based on a common control signal transmitted from the timing control unit 110.

A calculation processing unit 120 executes calculation processing based on the information detected by the light detection unit 100. The calculation processing unit 120 includes a traveling direction analysis unit 111, a space information extraction unit 112, and an image reconstitution unit 113.

The traveling direction analysis unit 111 calculates a traveling direction of laser light from pieces of light amount distribution information in the two-dimensional plane in a plurality of frames output from the light detection unit 100. In other words, the traveling direction analysis unit 111 acquires the traveling direction of light in an X-Y plane from pieces of information x (X direction information), y (Y direction information), and t (time information). The traveling direction analysis unit 111 may divide light tracks into a plurality of groups depending on each traveling direction of light.

The space information extraction unit 112 extracts space information of a Z direction component from among the traveling directions of light for each of the traveling directions of pulsed laser light calculated by the traveling direction analysis unit 111. In other words, the space information extraction unit 112 acquires the traveling direction of light in four-dimensional information of components x, y, z, and t from the three-dimensional information of components x, y, and t. By acquiring the traveling direction of light in the four-dimensional information of components x, y, z, and t, it is possible to acquire a normal vector of an object including the Z direction component. An acquisition method of the four-dimensional information will be described below in detail.

The image reconstitution unit 113 reconstitutes a shape of the object in an x-y-z three-dimensional space from information about the normal vector received from the space information extraction unit 112, and outputs the information to the display unit 114.

The display unit 114 displays an image based on a signal received from the image reconstitution unit 113. An image may be displayed on the display unit 114 by selecting a piece of information output from the image reconstitution unit 113 through a user operation.

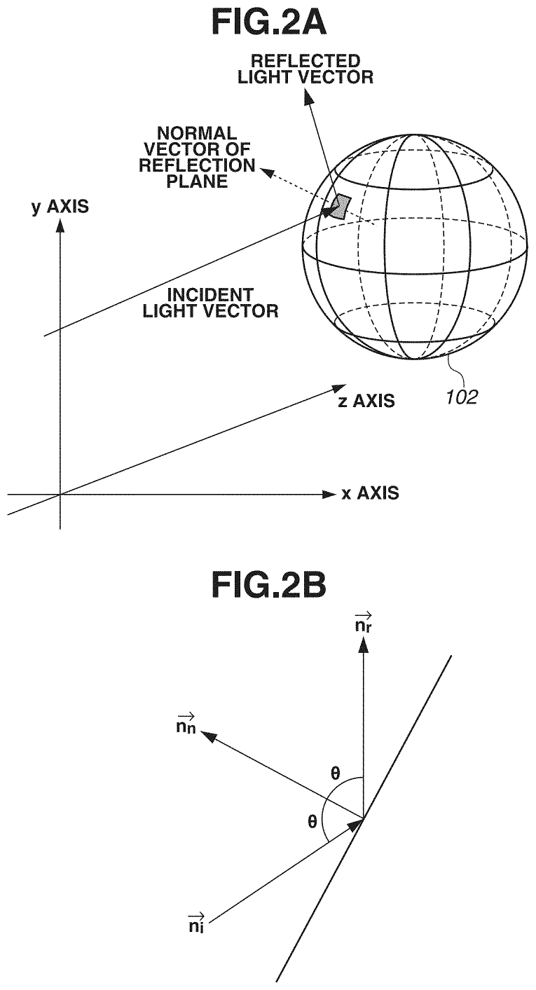

A general idea of a measurement method using the light detection system 1000 according to the present exemplary embodiment will be described with reference to FIGS. 2A and 2B.

FIG. 2B illustrates an incident light vector from a light source to the object 102 and a reflected light vector nᵣ from the object. In this specification, “vector” refers to a traveling direction of light in the x-y-z three-dimensional space. In the present exemplary embodiment, a normal vector in the x-y-z three-dimensional space is calculated from the incident light vector and the reflected light vector in the x-y-z three-dimensional space.

As illustrated in FIG. 2B, from the incident light vector and the reflected light vector nᵣ, a normal vector with respect to a reflection plane at an intersection point of the incident light vector and the reflected light vector nᵣ can be calculated. The above-described normal vector is a normal vector with respect to a reflection plane in a light emission range, and a normal vector with respect to a plane outside the light emission range is unknown. Accordingly, a normal vector is calculated with respect to each of the areas (light emission ranges) by emitting light from the light source while changing the light emission range of the object 102. In this way, a normal vector can be acquired for each of the areas, so that a three-dimensional shape of the object can be acquired.

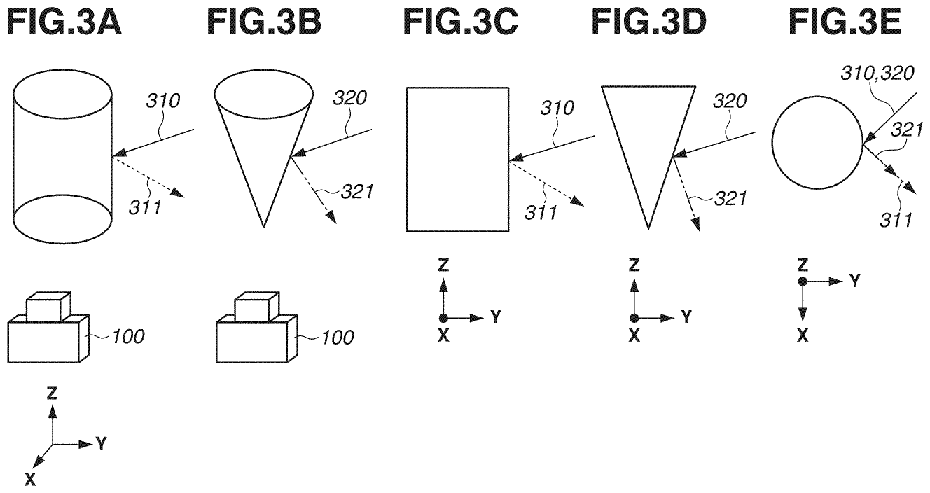

An effect of acquiring the incident light vector and the reflected light vector in the x-y-z three-dimensional space will be described with reference to FIGS. 3A to 3E. In FIGS. 3A to 3E, the effect will be described with respect to objects having a columnar shape and a conical shape. However, the shape of the object is not limited thereto. FIGS. 3A and 3B are diagrams illustrating arrangement positions of the object and the light detection unit 100 in the three-dimensional space. The light detection unit 100 is arranged to detect an X-Y plane of each of the objects. FIG. 3C is a diagram illustrating an incident light beam 310 and a reflected light beam 311 when the columnar object in FIG. 3A is observed in a Y-Z plane. FIG. 3D is a diagram illustrating an incident light beam 320 and a reflected light beam 321 when the conical object in FIG. 3B is observed in the Y-Z plane. FIG. 3E is a diagram illustrating incident light beams 310 and 320 and the reflected light beams 311 and 321 respectively acquired by the light detection unit 100 in FIG. 3A and the light detection unit 100 in FIG. 3B. Although the traveling directions of the incident light beams 310 and 320 are the same in FIGS. 3C and 3D, the traveling directions of the reflected light beams 311 and 321 are different in FIGS. 3C and 3D. However, as illustrated in FIG. 3E, there is a case where the traveling directions of the reflected light beams 311 and 321 detected by the light detection unit 100 are the same in the X-Y plane. In other words, although the traveling directions of the reflected light vectors are different when viewed in the x-y-z three-dimensional space, the reflected light beams acquired from the x-y-t three-dimensional information (i.e., x-y two dimensional space) may look the same for the columnar object and the conical object. In this case, when normal vectors are calculated based on the x-y-t three-dimensional information acquired from the light detection unit 100, the traveling directions of the normal vectors will be the same. Thus, from the normal vector calculated based on the three-dimensional information, it is not possible to determine whether the object has a columnar shape or a conical shape. As described above, there is a case where a normal vector cannot be acquired precisely when calculation is executed based on the x-y-t three dimensional information. While details will be described below, in the present exemplary embodiment, x-y-z-t four-dimensional information is calculated from the x-y-t three-dimensional information. Thus, according to the present exemplary embodiment, it is possible to calculate a precise normal vector in the x-y-z three-dimensional space. Accordingly, an x-y-z three-dimensional shape of the object can be calculated.

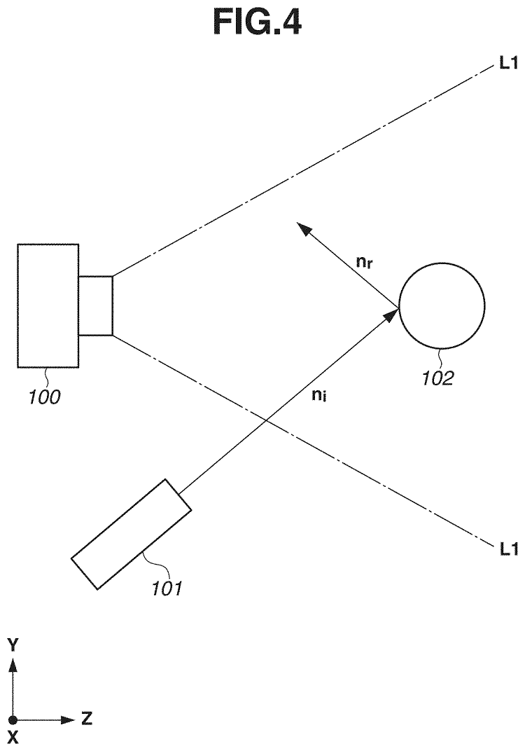

Examples of arrangement positions of the light detection unit 100, the light source 101, and the object 102 according to the present exemplary embodiment will be described with reference to FIG. 4. The light detection unit 100 captures images of the information of an X-Y plane. In this case, when the incident light beam from the light source and the reflected light beam nᵣ are detected by the light detection unit 100, a light beam in the X-Y plane is acquired as illustrated in FIG. 3. More specifically, the information detected by the light detection unit 100 includes the information about the x-y two-dimensional space, and does not include information about the Z direction. In the present exemplary embodiment, in order to acquire the information about the Z direction, space information of the Z direction is acquired from the space information of the X-Y plane and the time information (t). More specifically, the space information of the Z direction is acquired by using an “apparent speed” of diffusion light caused by pulsed laser light emitted from the light source 101. The “apparent speed” will be described below.

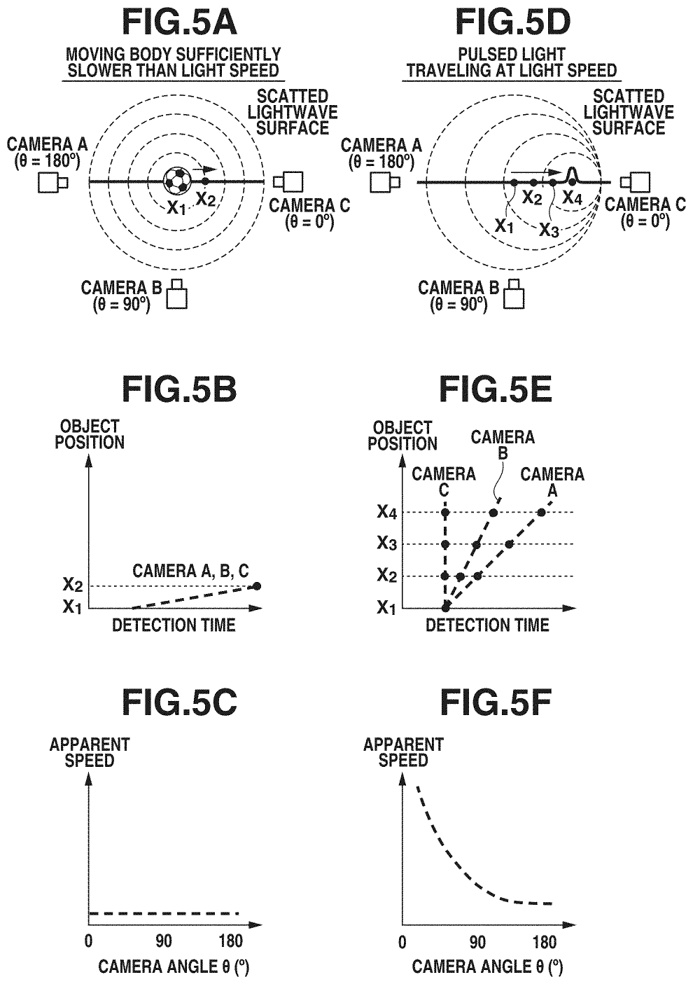

FIGS. 5A to 5F are diagrams illustrating a difference between an apparent speed of a moving body traveling at a speed sufficiently slower than a light speed and an apparent speed of pulsed light traveling at a light speed.

FIG. 5A illustrates a moving ball as an example of a moving body traveling at a speed sufficiently slower than light speed. In FIG. 5A, a camera C (θ=0°) is arranged at a position ahead of the moving body traveling in the traveling direction, a camera A (θ=180°) is arranged at a position behind the moving body traveling in the traveling direction, and a camera B (θ=90°) is arranged in a direction orthogonal to the traveling direction of the moving body.

FIG. 5B is a graph illustrating a relationship between a position of the moving body (object position) and time (detection time) at which each of the cameras A to C detects diffusion light from the moving body. Because the moving body is nearly motionless before diffusion light from the moving body reaches the cameras A, B, and C, detection times of the cameras A, B, and C exhibit the same tendencies.

FIG. 5C is a graph illustrating a relationship between an angle θ at which the camera is arranged with respect to the moving body traveling in the traveling direction and the apparent speed. The apparent speed corresponds to a moving amount of the moving body per detection time. Because the moving amount of the moving body per detection time is constant as illustrated in FIG. 5B, the apparent speed also becomes constant. FIG. 5C illustrates the above-described relationship. In other words, the apparent speed of the moving body becomes constant regardless of the traveling direction of the moving body with respect to each of the cameras A to C.

On the other hand, FIG. 5D illustrates an example of pulsed laser light traveling at the light speed. Similar to the case illustrated in FIG. 5A, in FIG. 5D, a camera C (θ=0°) is arranged at a position ahead of the pulsed laser light traveling in the traveling direction, a camera A (θ=180°) is arranged at a position behind the pulsed laser light traveling in the traveling direction, and a camera B (θ=90°) is arranged in a direction orthogonal to the traveling direction of the pulsed laser light.

FIG. 5E is a graph illustrating a relationship between the position of the pulsed laser light (object position) and time (detection time) at which each of the cameras A to C detects diffusion light generated from the pulsed light. The detection times of the cameras A to C arranged at different positions are different because pulsed light itself that generates diffusion light also travels further before diffusion light of the pulsed light generated at a predetermined position reaches each of the cameras A to C. More specifically, the camera C detects diffusion light generated at positions X1 to X4 simultaneously. On the other hand, because diffusion light generated at the positions X1 to X4 reaches the camera A in the order of the positions X1, X2, X3, and X4, the camera A detects the diffusion light generated at the respective positions X1 to X4 at different detection times. Similar to the case of the camera A, because diffusion light generated at the positions X1 to X4 reaches the camera B in the order of the object positions X1, X2, X3, and X4, the camera B detects the diffusion light generated at the respective positions X1 to X4 at different detection times. However, a distance between the arrangement position of the camera B and each of the positions where diffusion light is generated is approximately constant when compared to the case of the position where the camera A is arranged. Thus, intervals between detection times at which the camera B detects diffusion light generated at the respective positions are shorter than that of the camera A. As a result, a relationship illustrated in FIG. 5E is obtained.

FIG. 5F is a graph illustrating a relationship between an angle θ at which the camera is arranged with respect to the traveling direction of pulsed light and the apparent speed. As illustrated in FIG. 5E, the apparent speed, i.e., the moving amount of diffusion light per detection time, is different for each of the cameras A to C. More specifically, the apparent speed of diffusion light detected by the camera B (θ=90°) is greater than that of the camera A (θ=180°). Further, the apparent speed of diffusion light detected by the camera C (θ=0°) is infinity. This relationship is illustrated in FIG. 5D. In other words, the apparent speed of pulsed light changes depending on the traveling direction of pulsed light with respect to each of the cameras A to C.

As described above, by analyzing the speed in the traveling direction of light observed by the camera, a vector of the traveling direction of light in a new dimension (Z information) can be estimated. More specifically, information including information about the Z direction can be extracted from a data set including a plurality of pieces of light amount distribution information in the X-Y plane acquired by the light detection unit of the camera and a plurality of pieces of time information indicating time at which the pieces of light amount distribution information are acquired. Accordingly, four-dimensional spatiotemporal information can be acquired from three-dimensional spatiotemporal information. The light amount distribution information is distribution information of diffusion light.

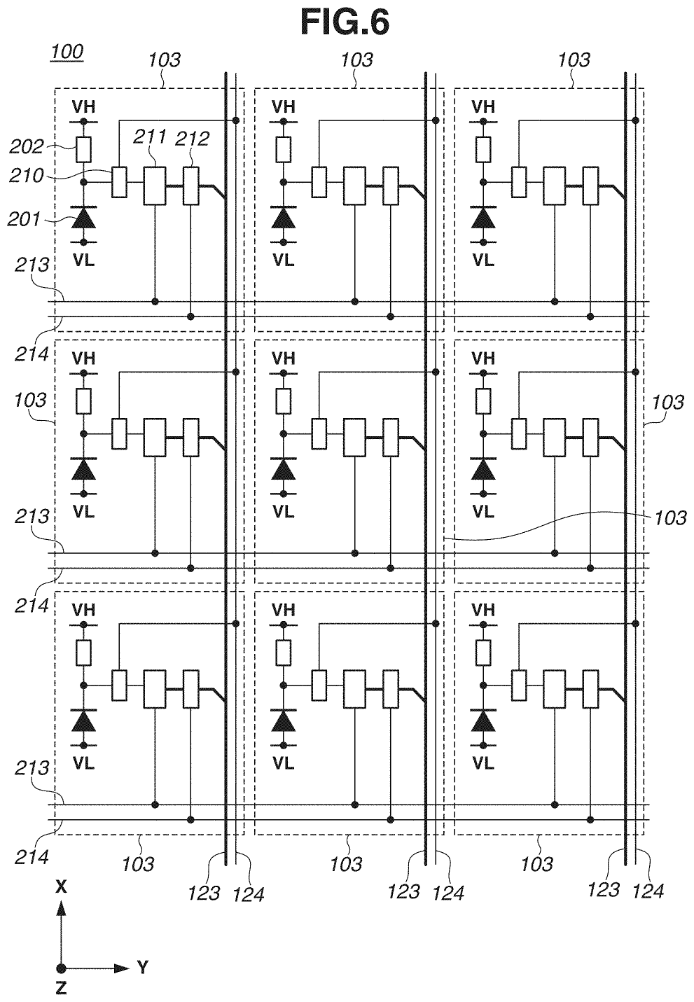

FIG. 6 is a diagram illustrating a pixel area of the light detection unit 100. An SPAD pixel 103 is repeatedly and two-dimensionally arranged in the pixel area in the X-Y direction.

The SPAD pixel 103 includes a photoelectric conversion portion 201 (avalanche diode), a quench element 202, a control unit 210, a counter/memory 211, and a readout unit 212.

A potential based on a potential VH higher than a potential VL supplied to an anode is supplied to a cathode of the photoelectric conversion portion 201. A potential is supplied to the anode and the cathode of the photoelectric conversion portion 201 so that a reverse bias for causing a photon entering the photoelectric conversion portion 201 to be multiplied by the avalanche multiplication is applied. By executing the photoelectric conversion in a state where a potential of the reverse bias is supplied thereto, avalanche multiplication occurs in the electric charges generated by the incident light to cause avalanche current to be generated.

In a case where a difference between the potentials of the anode and the cathode is greater than a breakdown voltage when the potential of the reverse bias is supplied thereto, the avalanche diode is brought into a Geiger mode operation. An avalanche diode for rapidly detecting a faint signal in a single-photon level using the Geiger mode operation is called “Single Photon Avalanche Diode (SPAD)”.

The quench element 202 is connected to a power source supplying the high potential VH and the photoelectric conversion portion 201. The quench element 202 is configured of a P-type metal oxide semiconductor (MOS) transistor or a resistor element such as a polysilicon resistor. In addition, the quench element 202 may be configured of a plurality of MOS transistors in serial connection. When photoelectric current is multiplied by the avalanche multiplication occurring in the photoelectric conversion portion 201, electric current acquired by the multiplied electric charges flows into a connection node of the photoelectric conversion portion 201 and the quench element 202. Because of a voltage drop caused by the electric current, a potential of the cathode of the photoelectric conversion portion 201 is lowered, so that an electronic avalanche is not produced in the photoelectric conversion portion 201. As a result, the avalanche multiplication occurring in the photoelectric conversion portion 201 is stopped. Thereafter, the potential VH is supplied to the cathode of the photoelectric conversion portion 201 from the power source via the quench element 202, so that the potential supplied to the cathode of the photoelectric conversion portion 201 returns to the potential VH. In this way, the operating range of the photoelectric conversion portion 201 is brought back to the Geiger mode operation again. As described above, when the electric charge is multiplied by the avalanche multiplication, the quench element 202 functions as a load circuit (quench circuit) to suppress the avalanche multiplication (i.e., quench operation). Further, after the avalanche multiplication is suppressed, the quench element 202 functions to bring the operation range of the avalanche diode to the Geiger mode.

The control unit 210 determines whether to count signals output from each of the photoelectric conversion portions 201. For example, the control unit 210 is a switch (gate circuit) arranged at a position between the photoelectric conversion portion 201 and the counter/memory 211. A gate of the switch is connected to a pulse line 124, and ON and OFF of the control unit 210 is switched depending on the signal input to the pulse line 124. A signal based on the control signal transmitted from the timing control unit 110 in FIG. 1 is input to the pulse line 124. Gates of the switches are c simultaneously controlled for all of the columns. With this configuration, all of the SPAD pixels are simultaneously controlled to start or end light detection. The above-described control is also called global-shutter control.

Further, the control unit 210 may be configured of a logic circuit instead of a switch. For example, an AND circuit is arranged as a logic circuit. Then, an output from the photoelectric conversion portion 201 is input thereto as a first input of the AND circuit, and a signal from the pulse line 124 is input thereto as a second input thereof. In this way, it is possible to switch whether to count the signals output from the photoelectric conversion portion 201.

Furthermore, the control unit 210 does not have to be arranged at a position between the photoelectric conversion portion 201 and the counter/memory 211, and the control unit 210 may be a circuit that inputs a signal for switching operation/non-operation of a counter of the counter/memory 211.

The counter/memory 211 counts the number of photons entering the photoelectric conversion portion 201 and saves the counted value as digital data. A reset line 213 is arranged for each of rows, so that the saved signal is reset when a control pulse is supplied to the reset line 213 from a vertical scanning circuit unit (not illustrated).

The readout unit 212 is connected to the counter/memory 211 and a readout signal line 123. A control pulse is supplied to the readout unit 212 from the vertical scanning circuit (not illustrated) via a control line, so that the readout unit 212 switches whether to output the count value of the counter/memory 211 to the readout signal line 123. For example, the readout unit 212 includes a buffer circuit for outputting signals.

The readout signal line 123 may be a signal line for outputting a signal to the calculation processing unit 120 from the light detection unit 100, or may be a signal line for outputting a signal to a signal processing unit arranged inside the light detection unit 100. Further, the horizontal scanning circuit unit (not illustrated) and the vertical scanning circuit unit (not illustrated) may be arranged on a substrate on which the SPAD array is arranged, or may be arranged on a substrate different from the substrate on which the SPAD array is arranged.

Further, while the counter is used in the above-described configuration, a time-to-digital converter (TDC) may be used instead of the counter, and information may be saved in a memory by acquiring a pulse detection timing.

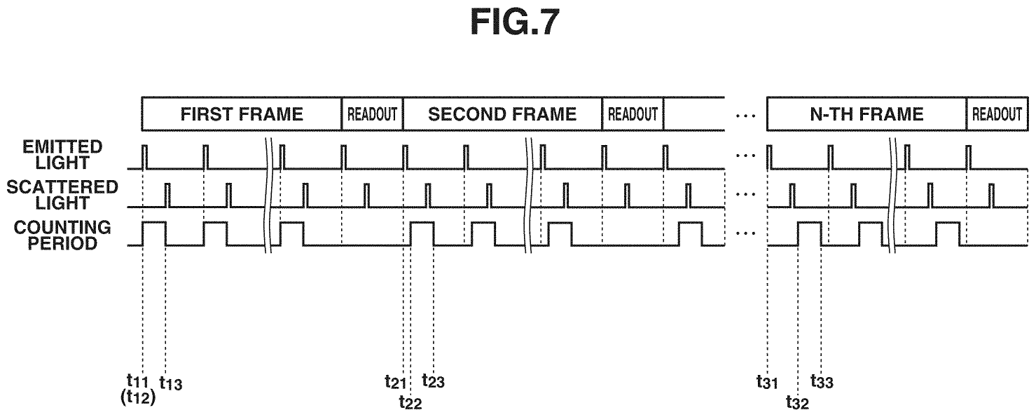

FIG. 7 illustrates a timing at which pulsed laser light is emitted from the light source 101 and a timing at which diffusion light generated from pulsed laser light emitted to a substance (e.g., water vapor and dust) reaches the light detection unit 100. FIG. 7 also illustrates a timing at which light detection (counting of light amount) is executed by the light detection unit 100.

In the first frame period, light emission and light detection are started at time t11 (t12), and the light detection is ended at time t13. In the first frame period illustrated in FIG. 7, diffusion light is not detected because the light detection unit 100 does not execute light detection when diffusion light has reached the light detection unit 100. In the first frame period, the light detection unit 100 executes light detection for a plurality of times in order to acquire the light amount distribution of the X-Y plane. When the plurality of times of light detection is ended in each frame period, values stored in the memory is read out.

As illustrated in FIG. 6, the light detection unit 100 includes a plurality of SPAD pixels arranged in an array, and the light detection start timing of all of the SPAD pixels arranged in each row is controlled simultaneously. In other words, in the first frame, light emission and counting are started for all of the SPAD pixels at the same timings, as illustrated in FIG. 7.

In the second frame, light emission is started at time t21, light detection is started at time t22, and light detection is ended at time 23. In comparison with the first frame, in the second frame, an interval between the start of light emission and the start of light detection is longer. In the second frame illustrated in FIG. 7, diffusion light is detected because the light detection unit 100 executes light detection when diffusion light reaches the light detection unit 100.

Thereafter, the respective frames are set so that an interval between the start of light emission and the start of light detection becomes gradually longer. More specifically, in the N-th frame, light is emitted at time tN1, light detection is started at time tN22, and the light detection is ended at time tN3.

The light detection unit 100 is a SPAD array configured of SPAD pixels arranged two-dimensionally. Accordingly, as illustrated in the above-described timing chart, a pair of data including light amount distribution information of the X-Y plane and time information indicating acquisition time of the light amount distribution information can be acquired for each of the frames. Therefore, it is possible to acquire the information relating to components x, y, and t.

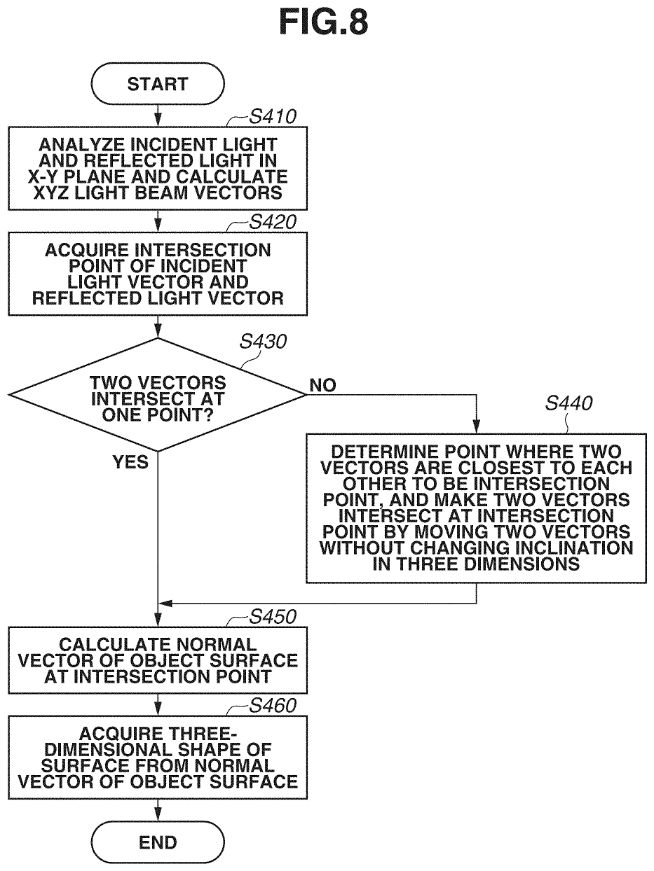

FIG. 8 is a flowchart illustrating calculation processing executed by the traveling direction analysis unit 111 and the space information extraction unit 112 illustrated in FIG. 1. When the calculation processing is started, in step S410, the traveling direction analysis unit 111 analyzes incident light and reflected light, and calculates traveling directions (vectors of light beams) of the incident light and the reflected light.

Next, in step S420, the traveling direction analysis unit 111 acquires an intersection point of the incident light vector and the reflected light vector. In step S430, if the intersection point is imaged by the light detection unit 100, and the incident light vector and the reflected light vector intersect at one point (YES in step S430), a coordinate thereof is taken as an intersection point, and the processing proceeds to step S450. If the intersection point is not imaged by the light detection unit 100, and information about the intersection point cannot be acquired directly (NO in step S430), the processing proceeds to step S440. In step S440, the traveling direction analysis unit 111 determines a point where the two vectors are closest to each other to be an intersection point, and makes the two vectors intersect at the intersection point by moving the two vectors without changing the inclination in three dimensions.

Next, in step S450, the space information extraction unit 112 searches for a function for fitting, and calculates a normal vector of an object surface at the intersection point. Positional information of a light track on a measured imaging surface (light amount distribution information of the X-Y plane) and time information corresponding to positional information of the light track are used for calculating the normal vector. A calculation model for searching for the function will be described below.

Next, in step S460, a three-dimensional shape of the object surface is acquired from the normal vector of the object surface.

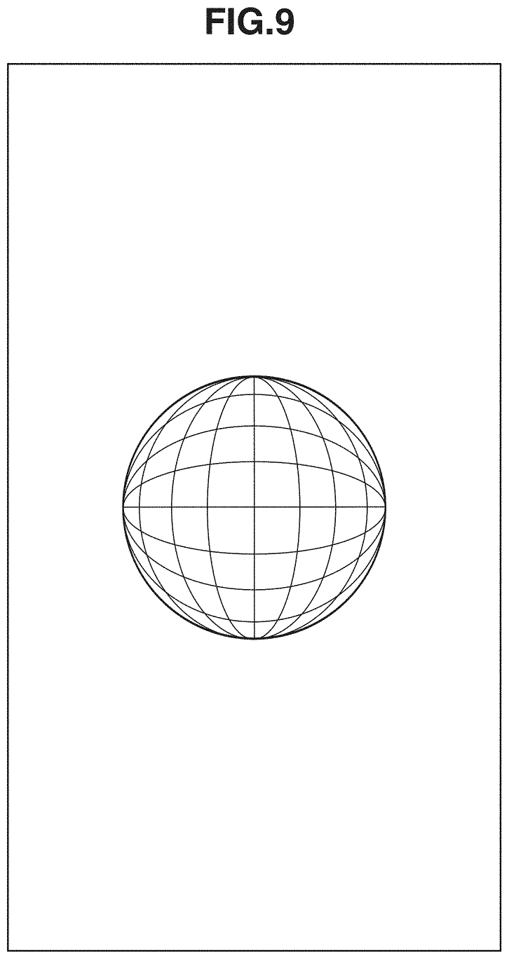

By repeatedly executing the processing in steps S410 to S460 while changing the light emission area (light emission range) of light emitted from the light source, it is possible to measure a three-dimensional shape of the object illustrated in FIG. 9.

### <Concept of Calculation Processing>

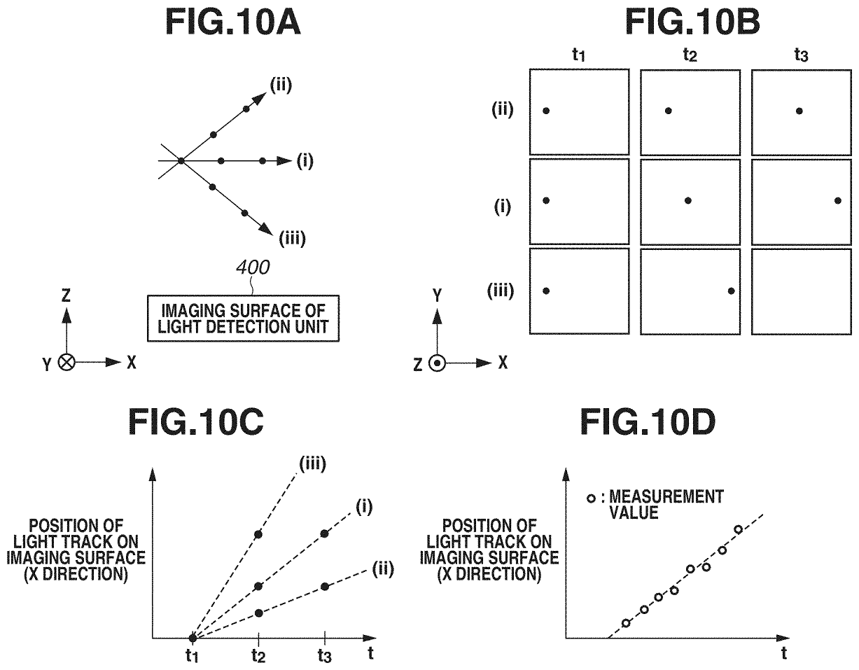

FIGS. 10A to 10D are diagrams illustrating a concept of the processing executed by the calculation processing unit 120.

An imaging surface 400 of the light detection unit 100 is illustrated in FIG. 10A. The imaging surface 400 includes an X-Y plane. Vectors of the traveling directions i to iii of light are indicated by arrows. The respective arrows indicate light traveling in a direction i parallel to the imaging surface 400, light traveling in a direction ii in which the light is away from the imaging surface 400, and light traveling in a direction iii in which the light travels toward the imaging surface 400. In FIGS. 10A to 10D, for the sake of simplicity, the light has vector components of the X direction and the Z direction, and does not have the vector components of the Y direction.

FIG. 10B is a diagram illustrating light tracks of light in the above-described traveling directions i to iii imaged at the imaging surface 400 at times t1 to t3. Herein, a light track is observed in a linear state when a frame rate is low. Further, when the apparent speed of light is slow, a light track with a string-like trail is observed. FIG. 10B illustrates a rising portion of light intensity (i.e., a beginning portion of the light track) with respect to the light traveling direction.

As illustrated in FIG. 10B, light includes vector components of the X direction and the Z direction. However, in the X-Y plane imaged at respective times, information about the Z direction cannot be extracted because the vector component of the Z direction is projected on the X-Y plane. As illustrated in FIG. 10B, the apparent speed of light in the traveling direction ii is slower than that of light in the traveling direction i. In contrast, the apparent speed of light in the traveling direction iii is faster than that of light in the traveling direction i.

FIG. 10C is a graph illustrating a relationship between times t1 to t3 and positions of the light tracks on the imaging surface in the X direction. In FIG. 10C, lights in the traveling directions i to iii, i.e., lights having different vector components of the Z direction, are described by different functions.

For example, when the description is given in linear approximation, the light track is described as “position in the X direction (objective variable)=a+b·time (explanatory variable)”, and coefficients a and b have different values depending on a difference in the vector component of Z direction.

In order to describe the actual light track, it is necessary to consider a vector component in the Y direction, a distance between a position where diffusion light is generated and an imaging surface of light detection, and a non-linear effect caused by temporal change of a direction vector from the light detection unit to pulsed light, associated with progression of the pulsed light. Thus, a calculation model becomes more complex because the numbers of variables and coefficients are increased. Even so, positional information of light at the imaging surface and time information are described in different functions depending on the vector component of light in the Z direction.

Similar to the graph in FIG. 10C, FIG. 10D is a graph illustrating data (measurement values) actually measured by the light detection unit 100, plotted on a time axis and an axis of a light position (X direction) on the imaging surface. A function for fitting is searched with respect to each of the measurement values. Then, a vector component in the Z direction can be estimated if a vector component in the Z direction can be extracted from the function.

In other words, based on the two-dimensional space information (vector information of the X-Z direction) and time information, a model for calculating one-dimensional positional information (vector information of the X direction) and time information on the light detection unit is created. Then, a vector component of the Z direction can be estimated if vector information of the X-Z direction and time information, which can sufficiently describe actual measurement data of X direction information and time information, can be found. This can also be said that an inverse issue is solved through the above-described calculation because the movement of light as an observation target is estimated from the actual measurement data.

Further, by extending a dimension, a model for calculating two-dimensional space information (vector information of the X-Y direction) and time information on the light detection unit is created from three-dimensional space information (vector information of the X-Y-Z direction) and time information. A vector component of the Z direction can be estimated if three-dimensional space information (vector information of the X-Y-Z direction) and time information that can sufficiently describe information of the X-Y direction and time information as actual measurement data can be searched. More specifically, three-dimensional space information and time information are acquired by fitting a data set with the two-dimensional space information and time information on the light detection unit calculated by using the model. Then, the vector component of the Z direction is estimated from the acquired three-dimensional space information and time information.

### <Description of Calculation Model>

Hereinafter, an example of the model used for calculation will be described. A more complex model taking lens aberration and ununiform sensor characteristics into consideration may be used instead of the below-described model. Further, parameter estimation using a neural network model may be executed instead of solving the least square.

Temporal change of a laser pulse position expressed by the expression 1 can be described as the expression 2.

$$\begin{matrix} \text{?} ( t ) & 〈 Expression 1 〉 \\ {r}^{r} ( t ) = ( x ( t ) , y ( t ) , z ( t ) ) = {{r}^{r}}_{0} + ct \cdot {n}^{r} & 〈 Expression 2 〉 \\ \text{?} \text{indicates text missing or illegible when filed} & \end{matrix}$$

Herein, the expression 3 is a constant vector not depending on time, “c” is a speed of light, and the expression 4 is a normalized vector that indicates a light propagating direction.

$$\begin{matrix}{{r}^{r}}_{0} = ( {x}_{0} , {y}_{0} , {z}_{0} ) & 〈 Expression 3 〉 \\ {n}^{r} = ( {n}_{x} , {n}_{y} , {n}_{z} ) & 〈 Expression 4 〉\end{matrix}$$

Herein, “t” is a time when a laser pulse has reached a position indicated by the expression 5, and the time t has an offset with respect to time

$$\begin{matrix} \text{?} ( t ) & 〈 Expression 5 〉 \\ \text{?} \text{indicates text missing or illegible when filed} & \end{matrix}$$

The time t′ is time when a laser pulse located at a position expressed by the expression 6 is detected by a camera.

$$\text{?} \text{?} \text{indicates text missing or illegible when filed} \qquad 〈 Expression 6 〉$$

A position of the laser pulse projected onto an imaging surface (focusing surface) of the light detection device is expressed by the expression 7.

$$\text{?} ( t ) = ( {x}_{p} , {y}_{p} , {z}_{p} ) = α ( t ) \cdot \text{?} ( t ) \\ \text{?} \text{indicates text missing or illegible when filed} \qquad 〈 Expression 7 〉$$

Herein, “α(t)” is a coefficient depending on time, and “−zₚ” is a focal distance. If the focal distance zₚ does not depend on time, the coefficient α(t) can be described as α(t)=zₚ/(z₀+ct·nₜ). Movement of a laser pulse geometrically projected on the imaging surface of the light detection device can be described as the following expression 8.

$${x}_{p} ( t ) = \frac{{z}_{p}}{{z}_{0} + ct \cdot {n}_{z}} \cdot ( {x}_{0} + ct \cdot {n}_{x} ) , \\ {y}_{p} ( t ) = \frac{{z}_{p}}{{z}_{0} + ct \cdot {n}_{z}} \cdot ( {y}_{0} + ct \cdot {n}_{y} ) . \qquad 〈 Expression 8 〉$$

If time taken to propagate light from the laser pulse position to the light detection device is taken into consideration, observation time t′ can be described by the following expression 10.

$$\begin{matrix}{r}^{r} ( t ) & 〈 Expression 9 〉 \\ {t}^{′} = t + \frac{\vert {r}^{r} ( t ) \vert}{c} = t + \frac{1}{c} \cdot \sqrt{{\vert {{r}^{r}}_{0} \vert}^{2} + 2 ct ( {{r}^{r}}_{0} \cdot {n}^{r} ) + {c}^{2} {t}^{2}} . & 〈 Expression 10 〉\end{matrix}$$

When the above expression 10 is solved, the following expression 11 can be acquired.

$$t = f ( {t}^{′} ) = \frac{1}{2} \cdot \frac{{c}^{2} {t}^{′ 2} - {\vert {{r}^{r}}_{0} \vert}^{2}}{{c}^{2} {t}^{′} + c ( {{r}^{r}}_{0} \cdot {n}^{r} )} . \qquad 〈 Expression 11 〉$$

The expression 11 is substituted for the expression 8, so that a position of laser pulsed light projected on the imaging surface, i.e., a function of the observation time t′, can be described by the following expression 12.

$$\begin{matrix}{x}_{p} ( {t}^{′} ) = \frac{{z}_{p}}{{z}_{0} + c \cdot f ( {t}^{′} ) \cdot {n}_{z}} \cdot ( {x}_{0} + c \cdot f ( {t}^{′} ) \cdot {n}_{x} ) , & 〈 Expression 12 〉 \\ {y}_{p} ( {t}^{′} ) = \frac{{z}_{p}}{{z}_{0} + c \cdot f ( {t}^{′} ) \cdot {n}_{z}} \cdot ( {y}_{0} + c \cdot f ( {t}^{′} ) \cdot {n}_{y} ) . & \end{matrix}$$

Through time-resolved measurement, N sets of data of a three-dimensional data point (Xⁱₚ, Yⁱₚ, Tⁱ) can be acquired (i=1, 2, . . . , N). In order to recreate four-dimensional light, six parameters, x₀, y₀, z₀, nₓ, n_{y}, n_{z} are set, and an optimization issue expressed by the following expression 13 is solved.

$${ 〈 Expression 13 〉 \\ ( {{r}^{r}}_{0} , {n}^{r} ) = {arg min}_{{{r}^{r}}_{0} , {n}^{r}} [ {{{\sum }_{i}}^{N} \{ {X}_{p}^{i} - \frac{{z}_{p}}{{z}_{0} + c \cdot f ( {T}^{′ i} ) \cdot {n}_{z}} \cdot ( {x}_{0} + c \cdot f (}_{i} {T}^{′ i} ) \cdot {n}_{x} ) \}}^{2} + {\sum }_{i}^{N} {\{ {Y}_{p}^{i} - \frac{{z}_{p}}{{z}_{0} + c \cdot f ( {T}^{′ i} ) \cdot {n}_{z}} \cdot ( {y}_{0} + c \cdot f ( {T}^{′ i} ) \cdot {n}_{y} ) \}}^{2} ] ,$$

Herein, N is the number of entire measurement data points, (Xₚⁱ, Yₚⁱ) is a position of a pixel on an imaging surface with respect to the i-th data point, −zₚ is a focal distance, Tⁱ is observation time measured with respect to the i-th data point, and Expression 14 is a position of laser light when t=0.

\vec{r}₀=(x₀,y₀,z₀) <Expression 14>

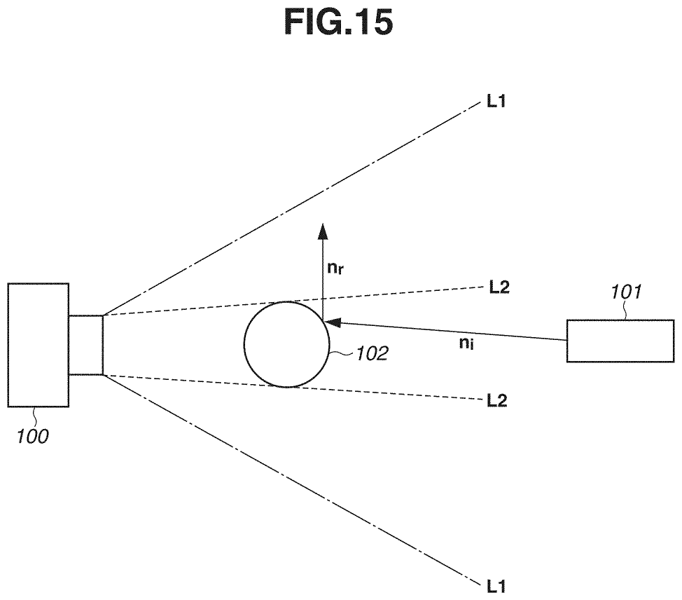

In the expression 13, a normalized light propagating vector is expressed as FIG. 15 in a polar coordinate system.

\vec{n}=(sin θ cos ϕ, sin θ sin ϕ, cos θ) <Expression 15>

When the expression 13 is converted to a polar coordinate, the following expressions 16 and 17 are acquired.

$$〈 Expression 16 〉$$

$$( {{r}^{r}}_{0} , θ , ϕ ) = {arg min}_{{{r}^{r}}_{0} , θ , ϕ} [ {\sum }_{i}^{N} {\{ {X}_{p}^{i} - \frac{{z}_{p}}{{z}_{0} + c \cdot f ( {T}^{′ i} ) \cdot cos θ} \cdot ( {x}_{0} + c \cdot f ( {T}^{′ i} ) \cdot sin θ cos ϕ ) \}}^{2} + {\sum }_{i}^{N} {\{ {Y}_{p}^{i} - \frac{{z}_{p}}{{z}_{0} + c \cdot f ( {T}^{′ i} ) \cdot cos θ} \cdot ( {y}_{0} + c \cdot f ( {T}^{′ i} ) \cdot sin θ sin ϕ ) \}}^{2} ] , \\ 〈 Expression 17 〉$$

$$f ( {T}^{′} ) = \frac{1}{2} \cdot \frac{{c}^{2} {T}^{′ 2} - ( {x}_{0}^{2} + {y}_{0}^{2} + {z}_{0}^{2} )}{{c}^{2} {T}^{′} + c ( {x}_{0} sin θ cos ϕ + {y}_{0} sin θ sin ϕ + {z}_{0} cos θ )} ,$$

In the above expressions 16 and 17, an optimization issue is solved by setting five parameters, x₀, y₀, z₀, θ, and ϕ.

The above-described model has the following three characteristics.

Firstly, the calculation is executed based on supposition of “rectilinear propagation characteristic of light” and “law of light speed constancy”. Secondly, the two-dimensional coordinate (Xp, Yp) on the imaging surface is calculated from a projection on the imaging surface with respect to the position (x, y, z) of the pulsed light. Thirdly, the detection time T′ is calculated with consideration for time taken for diffusion light to reach the camera with respect to time t when pulsed light has reaches the position (x, y, z).

When the optimization issue is solved with respect to a track where the number of data points is small, there is a possibility that values are diverged or converged on an incorrect solution. This issue is avoidable if continuity of light track is assumed. More specifically, when a plurality of light tracks exists, a limiting condition that a starting point of the second track is an ending point of the first track is added.

More specifically, with respect to the second track, a cost function (loss function), λ·((x_{c}−x₀−ct_{c}·nₓ)²+(y_{c}−y₀−ct_{c}·n_{y})²+(z_{c}−z₀−ct_{c}·n_{z})²), may be added to the expression 13. Herein, (x_{c}, y_{c}, z_{c}, t_{c}) is a four-dimensional coordinate of the ending point of the first track. Alternatively, instead of adding the limiting condition to the formula of the least square, the ending point of the first track may be set as an initial condition for estimating the second track.

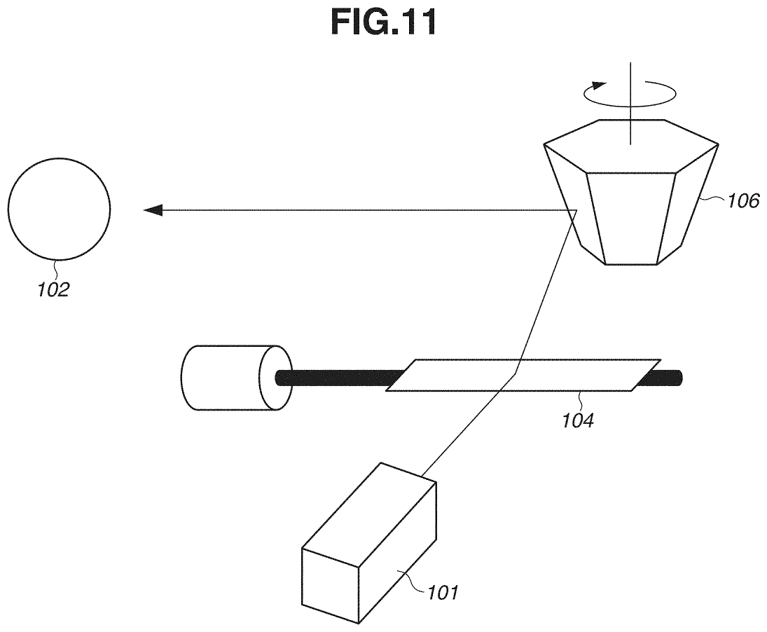

A configuration of the light detection system according to a second exemplary embodiment will be described with reference to FIG. 11. The present exemplary embodiment is different from the first exemplary embodiment in that light emitted from the light source 101 is reflected on a reflection body 104, and a light emission position of the laser light is changed by a microelectromechanical system (MEMS) mirror 106. The rest of the configuration is substantially the same as the configuration in the first exemplary embodiment, so that descriptions thereof will be omitted.

According to the present exemplary embodiment, similar to the first exemplary embodiment, a three-dimensional shape of the object can be acquired even in a case where the light detection unit cannot receive light reflected from the object. Further, because the light source 101 as a heat generation body can be fixed to a heat dissipation member, it is possible to improve the heat dissipation performance in comparison to the case where the light source 101 is moved.

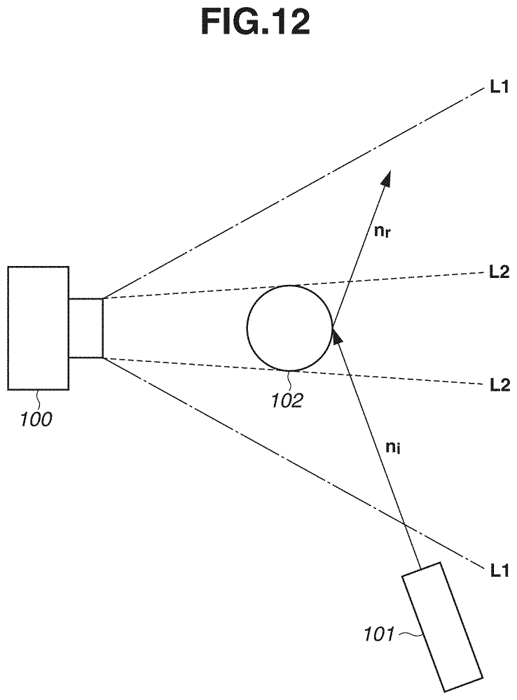

A configuration of a light detection system according to a third exemplary embodiment will be described with reference to FIG. 12. The present exemplary embodiment is different from the first exemplary embodiment in that a reflection plane of the object 102, on which light emitted from the light source 101 is reflected, is located in a blind area between boundaries L2 of the light detection unit 100, although the object 102 is located in an area between boundaries L1 of the field of view of the light detection unit 100. The rest of the configuration is substantially the same as the configuration in the first exemplary embodiment, so that descriptions thereof will be omitted.

In the present exemplary embodiment, the reflection plane of the object 102 is located in a blind area between the boundaries L2. Accordingly, the light detection unit 100 cannot detect an intersection point of the incident light vector and the reflected light vector nᵣ. However, the intersection point of the incident light vector nᵢ and the reflected light vector nᵣ is estimated from the incident light vector and the reflected light vector nᵣ. Then, the light detection unit 100 calculates a normal vector from the estimated intersection point to estimate a shape of the object 102.

According to the present exemplary embodiment, similar to the first exemplary embodiment, a three-dimensional shape of the object can be acquired even in a case where the light detection unit 100 cannot receive light reflected from the object 102. Further, a shape of the object 102 located in a blind area of the light detection unit 100 can also be calculated.

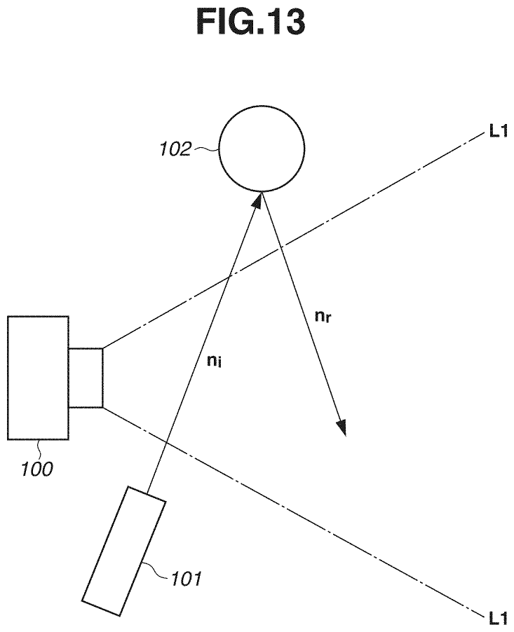

A configuration of a light detection system according to a fourth exemplary embodiment will be described with reference to FIG. 13. The present exemplary embodiment is different from the third exemplary embodiment in that the object 102 is not located within an area between the boundaries L1 of the field of view of the light detection unit 100. Since the configuration is substantially the same as the configuration described in the third exemplary embodiment except for the below-described configuration, descriptions thereof will be omitted.

As illustrated in FIG. 13, in the present exemplary embodiment, the object 102 is not detected by the light detection unit 100. More specifically, the object 102 is arranged outside the area between the boundaries L1 of the field of view of the light detection unit 100 (i.e., an area outside the field of view). In the present exemplary embodiment, the light detection unit 100 calculates a shape of the object by calculating the normal vector of the object 102 from the incident light vector and the reflected light vector nᵣ.

According to the present exemplary embodiment, similar to the first exemplary embodiment, a shape of the object 102 can be acquired even in a case where it is not possible to receive light reflected from the object 102. Further, as long as the incident light vector and the reflected light vector nᵣ are detectable, the object 102 does not have to be arranged at a position detectable by the light detection unit 100. Accordingly, a degree of freedom can be improved with respect to the arrangement positions of the light detection unit 100 and the object 102.

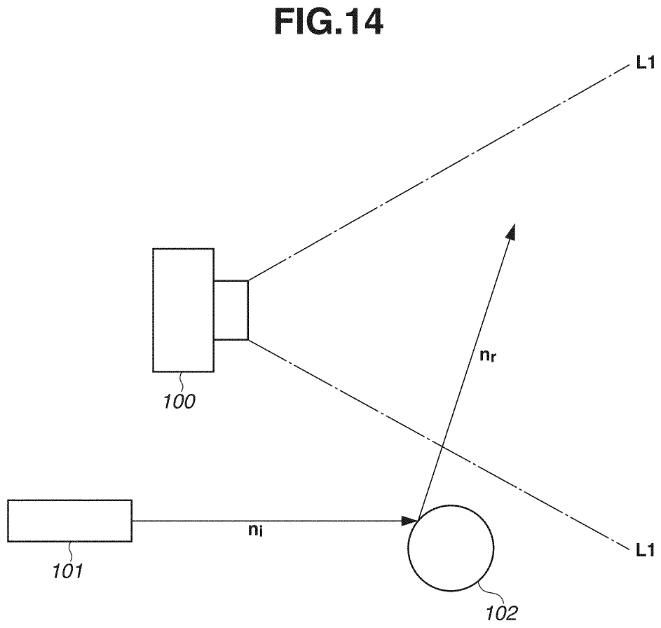

A configuration of a light detection system according to a fifth exemplary embodiment will be described with reference to FIG. 14. The present exemplary embodiment is different from the fourth exemplary embodiment in that an incident light beam is not detected by the light detection unit 100, although a light beam reflected from the object 102 is detected by the light detection unit 100. The rest of the configuration is substantially the same as the configuration described in the fourth exemplary embodiment, so that descriptions thereof will be omitted.

The present exemplary embodiment will be described based on the assumption that the light detection system has already acquired the information about the incident light vector n₁ from the light source 101 to the object 102. In this case, the reflected light vector nᵣ is calculated from the reflected light beam detected by the light detection unit 100, and a normal vector is calculated by combining the information about the incident vector and the information about the reflected light vector nᵣ.

According to the present exemplary embodiment, similar to the fourth exemplary embodiment, a three-dimensional shape of the object 102 can be acquired even in a case where the reflected light is not received by the light detection unit 100. Further, a degree of freedom can be improved with respect to the arrangement positions of the light detection unit 100 and the object 102.

A configuration of a light detection system according to a sixth exemplary embodiment will be described with reference to FIG. 15. The present exemplary embodiment is different from the third exemplary embodiment in that an incident light beam and the light source 101 are not detected by the light detection unit 100, although a light beam reflected from the object 102 is detected by the light detection unit 100. The rest of the configuration is substantially the same as the configuration described in the third exemplary embodiment, so that descriptions thereof will be omitted.

The present exemplary embodiment will be described based on the assumption that the light detection system has previously acquired the information about the incident light vector n₁ from the light source 101 to the object 102. For example, as illustrated in FIG. 15, the light source 101 and an incident light beam are positioned within a blind area of the light detection unit 100 between the boundaries L2. In this case, the light detection unit 100 cannot image the incident light beam, so that the incident light vector cannot be acquired from the light detection unit 100. Then, in the present exemplary embodiment, the reflected light vector nᵣ is calculated from the information about the reflected light beam detected by the light detection unit 100, and a normal vector is calculated by combining the information about the reflected light vector nᵣ and the information about the incident light vector nᵢ saved by the light detection system.

According to the present exemplary embodiment, similar to the third exemplary embodiment, a three-dimensional shape of the object 102 can be acquired even if the reflected light is not received by the light detection unit 100. Further, a shape of the surface of the object 102 located in the blind area of the light detection unit 100 can also be calculated from the information about the incident light vector nᵢ and the information about the reflected light vector nᵣ acquired by the light detection unit 100.

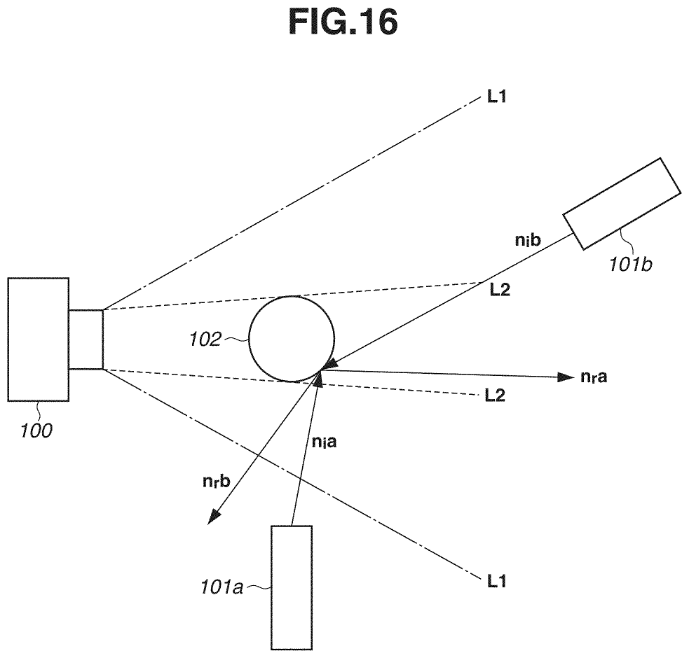

A configuration of a light detection system according to a seventh exemplary embodiment will be described with reference to FIG. 16. The present exemplary embodiment is different from the sixth exemplary embodiment in that light is emitted to the object 102 from a plurality of light sources 101, and a shape of the object 102 is measured by using light beams emitted from the light sources 101 and reflected from the object 102. The rest of the configuration is substantially the same as the configuration described in the sixth exemplary embodiment, so that descriptions thereof will be omitted.

In the present exemplary embodiment, a shape of the object 102 is measured by using light sources 101a and 101b. The light detection unit 100 estimates a shape of the object 102 by using an incident light vector nᵢa from the light source 101a, a reflected light vector nᵣa, and an incident light vector nᵢb from the light source 101b.

According to the present exemplary embodiment, similar to the sixth exemplary embodiment, a three-dimensional shape of the object 102 can be acquired even if the reflected light is not received by the light detection unit 100. Further, a shape of the surface of the object 102 located in a blind area of the light detection unit 100 can also be calculated from the information about the incident light vector and the information about the reflected light vector acquired by the light detection unit 100. Further, even if the object 102 is located in a blind area when a single light source is arranged thereon, a probability of detecting light can be increased by using a plurality of light sources. Furthermore, because a shape of the object 102 is estimated by using the plurality of light sources 101a and 101b, accuracy of shape estimation can be improved.

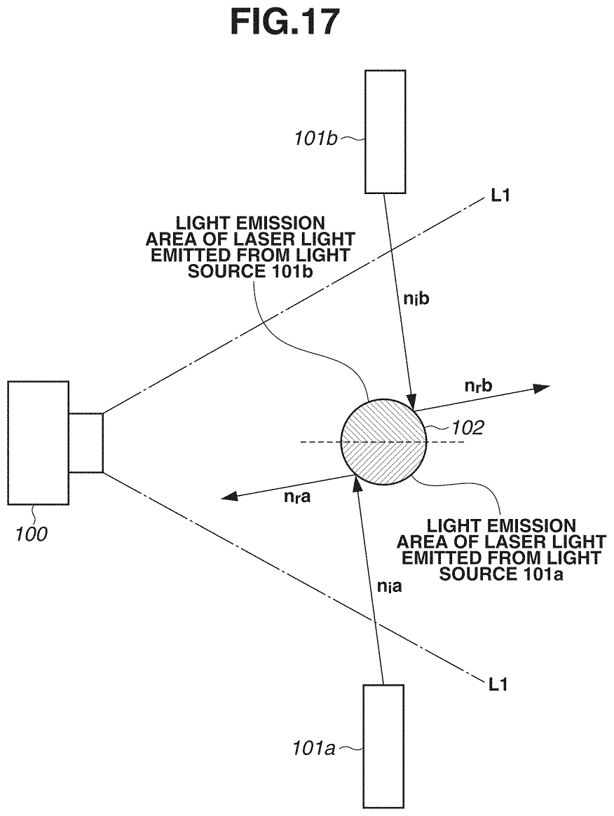

A configuration of a light detection system according to an eighth exemplary embodiment will be described with reference to FIG. 17. The present exemplary embodiment is different from the seventh exemplary embodiment in that the light sources 101a and 101b emit laser light to different light emission ranges of the object 102. The rest of the configuration is substantially the same as the configuration described in the seventh exemplary embodiment, so that descriptions thereof will be omitted.

In the present exemplary embodiment, a shape of the object 102 is measured by using the light sources 101a and 101b. In a state where the object 102 is divided into a plurality of portions, the light source 101a is used to detect one portion from among the plurality of divided portions of the object 102, whereas the light source 101b is used to detect another portion.

According to the present exemplary embodiment, similar to the other exemplary embodiments, a three-dimensional shape of the object 102 can be acquired even if the reflected light is not received by the light detection unit 100. Further, it is possible to reduce time taken to measure the shape of the object 102.

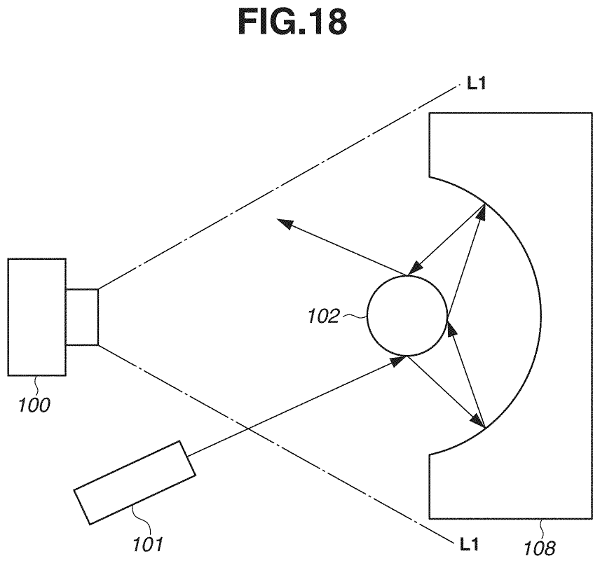

A configuration of a light detection system according to a ninth exemplary embodiment will be described with reference to FIG. 18. The present exemplary embodiment is different from the first exemplary embodiment in that a shape of the object 102 is measured in a state where the object 102 is arranged at a position between the light detection unit 100 and a mirrored-surface body 108. The rest of the configuration is substantially the same as the configuration described in the first exemplary embodiment, so that descriptions thereof will be omitted.

The light detection system according to the present exemplary embodiment acquires information about a back side of the object 102 (i.e., a blind area of the light detection unit 100) by making light emitted from the light source 101 be reflected for a plurality of times on the mirrored-surface body 108 and the object 102.

In one embodiment, a reflection plane of the mirrored-surface body 108 is a concaved surface. With this configuration, light can easily be reflected on the object 102.

According to the present exemplary embodiment, similar to the other exemplary embodiments, a three-dimensional shape of the object 102 can be acquired even if the reflected light is not received by the light detection unit 100. Further, information about the blind area of the light detection unit 100 can also be detected by the light detection unit 100.

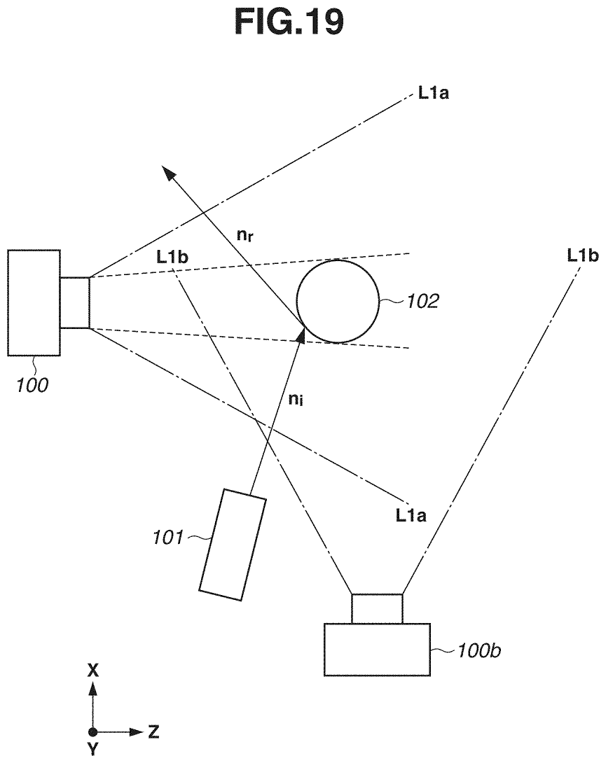

A configuration of a light detection system according to a tenth exemplary embodiment will be described with reference to FIG. 19. The present exemplary embodiment is different from the first exemplary embodiment in that a shape of the object 102 is measured by using a plurality of light detection units 100a and 100b. The rest of the configuration is substantially the same as the configuration described in the first exemplary embodiment, so that descriptions thereof will be omitted.

In the present exemplary embodiment, a shape of the object 102 is measured by using the light detection units 100a and 100b. The object 102 is located in an area within boundaries L1a of the field of view of the light detection unit 100a and boundaries L1b of the field of view of the light detection unit 100b. The light detection units 100a and 100b are arranged at different positions. The light detection unit 100a detects an X-Y plane, whereas the light detection unit 100b detects a Y-Z plane. As described above, the light detection unit 100b is arranged to detect a two-dimensional plane different from a two-dimensional plane detected by the light detection unit 100a.

In the present exemplary embodiment, the X-Y plane is detected by the light detection unit 100a, and a plane including a component of the Z direction is detected by the light detection unit 100b. Accordingly, the incident light vector and the reflected light vector nᵣ in the three-dimensional space can be acquired from the light detection units 100a and 100b without using “apparent speed” described in the first to the ninth exemplary embodiments. Therefore, the normal vector can be calculated, and the three-dimensional shape of the object can be measured without using the apparent speed.

In the exemplary embodiment using the apparent speed, the incident light vector and the reflected light vector are acquired by using diffusion light. In the present exemplary embodiment, light amount distribution information of laser light itself may be used.

According to the present exemplary embodiment, similar to the other exemplary embodiments, a three-dimensional shape of the object 102 can be acquired even if reflected light is not received by the light detection unit 100. Further, a load placed on the image processing can be reduced because the apparent speed does not have to be used. Furthermore, the reflected light can be detected by the other light detection unit 100b even if the reflected light is in the blind area of the light detection unit 100a. Therefore, it is possible to improve detection accuracy.

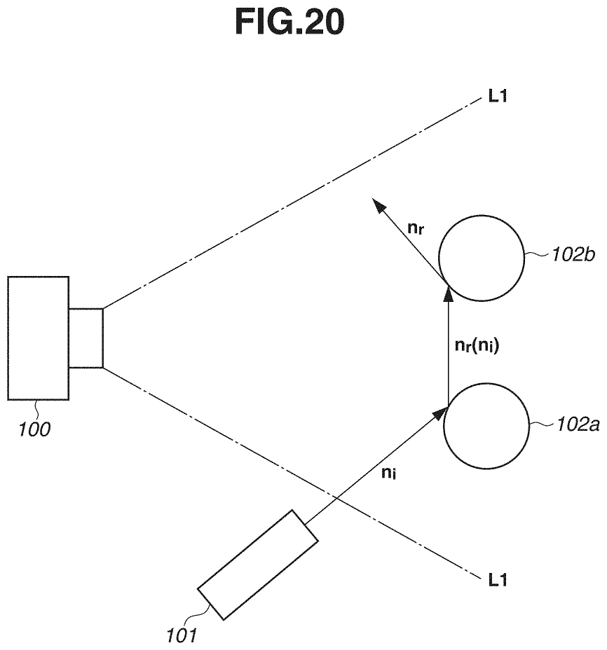

A configuration of a light detection system according to an eleventh exemplary embodiment will be described with reference to FIG. 20. The present exemplary embodiment is different from the first exemplary embodiment in that the light detection unit 100 detects incident light vectors and reflected light vectors for a plurality of objects 102a and 102b. The rest of the configuration is substantially the same as the configuration described in the first exemplary embodiment, so that descriptions thereof will be omitted.

As illustrated in FIG. 20, a normal vector of the object 102a is calculated from the incident light vector from the light source 101 and the reflected light vector nᵣ. Then, a normal vector of the object 102b is calculated from the reflected light vector nᵣ from the object 102a and the reflected light vector nᵣ from the object 102b.

According to the present exemplary embodiment, similar to the other exemplary embodiments, a three-dimensional shape of the object 102 can be acquired even if reflected light is not received by the light detection unit 100. Further, a shape can be calculated without using light directly incident from the light source 101.

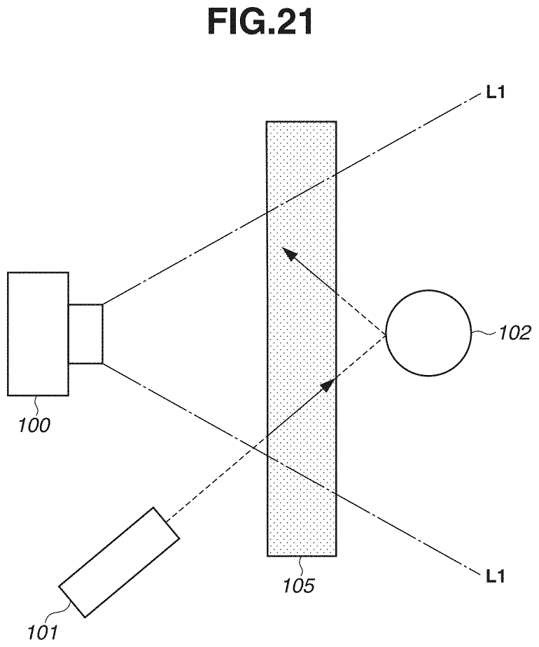

A configuration of a light detection system according to a twelfth exemplary embodiment will be described with reference to FIG. 21. The present exemplary embodiment is different from the first exemplary embodiment in that a translucent member 105 is arranged between the light detection unit 100 and the object 102. The rest of the configuration is substantially the same as the configuration described in the first exemplary embodiment, so that descriptions thereof will be omitted.

As illustrated in FIG. 21, the translucent member 105 is arranged between the light detection unit 100 and the object 102. Because the translucent member 105 is arranged therebetween, light beams can be detected more easily. In one embodiment, a difference between a refractive index of a space where the light beam is emitted and a refractive index of the translucent member 105 is 0.5 or less. For example, water vapor or dust can be used as the translucent member 105.

As illustrated in FIG. 21, similar to the other exemplary embodiments, when the translucent member 105 is arranged between the light detection unit 100 and the object 102, a three-dimensional shape of the object 102 can also be acquired even if reflected light is not received by the light detection unit 100.

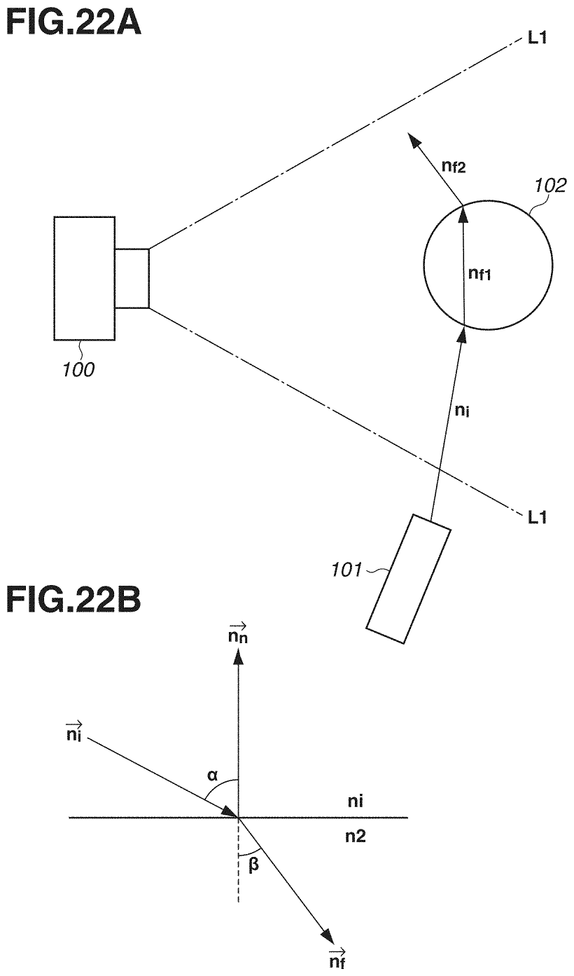

A configuration of a light detection system according to a thirteenth exemplary embodiment will be described with reference to FIGS. 22A and 22B. The present exemplary embodiment is different from the first exemplary embodiment in that a normal vector of a refractive surface of the object 102 is calculated from an incident light vector n, and a refracting light vector n_{f} with respect to the object 102. The rest of the configuration is substantially the same as the configuration described in the first exemplary embodiment, so that descriptions thereof will be omitted.

The light detection unit 100 detects the incident light vector and the refracting light vector n_{f2} in the X-Y plane of the object 102. Similar to the first exemplary embodiment, the incident light vector nᵢ in the x-y-z-t four dimensional information is calculated from an incident light beam, and a refracting light vector n_{f2} in the x-y-z-t four dimensional information is calculated from a refracting light beam. The refracting light vector n_{f1} traveling through the inside of the object 102 is estimated by connecting a point where the incident light vector enters the object 102 (a point where a vector is changed) and a point where the incident light vector ni exits from the object 102.

As illustrated in FIG. 22B, a normal vector of a boundary surface of an object can be estimated from refractive indexes of the object 102 and its periphery, the incident light vector, and the above-described refracting light vector n_{f1}. In a case where a refractive index of a space where the object 102 exists and a refractive index of the object 102 are known, an angle α between the incident light vector and the normal vector nₙ and an angle β between the normal vector nₙ and the refracting light vector n_{fi} are unambiguously determined by the Snell's law, i.e., sin α/sin β=nᵢ/n₂. Through the above calculation, the normal vector nᵣ, can be acquired. A normal vector can similarly be acquired at the boundary surface where the refracting light vector n_{fi} and the refracting light vector n_{f2} intersect with each other.

According to the present exemplary embodiment, similar to the other exemplary embodiments, when light enters the object 102, a three-dimensional shape of the object 102 can also be acquired even in a case where the reflected light is not received by the light detection unit 100.

The present disclosure is not limited to the above-described exemplary embodiments, and various changes and modifications are possible. For example, an exemplary embodiment in which a part of the configurations according to any one of the above-described exemplary embodiments is added to another exemplary embodiment or replaced with a part of the configurations according to another exemplary embodiment is also included in the exemplary embodiments of the present disclosure.

In addition, the above-described exemplary embodiments are merely examples embodying the present disclosure, and shall not be construed as limiting the technical range of the present disclosure. In other words, the present disclosure can be realized in various ways without departing from the technical spirit or the main features of the present disclosure.

According to the aspect of the present disclosure, it is possible to provide a light detection system capable of acquiring information about an object even in a case where the light detection unit cannot receive light reflected on the object.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-124549, filed Jul. 21, 2020, which is hereby incorporated by reference herein in its entirety.

What is claimed is:

1. A light detection system comprising:
a light detection unit including a plurality of photoelectric conversion portions arranged in a two-dimensional plane; and
a calculation processing unit configured to execute calculation based on information acquired by the light detection unit,
wherein the light detection unit acquires light amount distribution information of light based on an incident light beam incident on an object from a laser light source and light amount distribution information of light based on a reflected light beam reflected on the object in the two-dimensional plane,
wherein the calculation processing unit calculates, from the light amount distribution information of light based on the incident light beam, the light amount distribution information of light based on the reflected light beam, and time information about time at which the light amount distribution information of light based on the incident light beam and the light amount distribution information of light based on the reflected light beam are acquired, information about a normal vector with respect to a reflection plane of the object on which the incident light beam is reflected, and
wherein the normal vector is a vector in three dimensions including a direction orthogonal to the two-dimensional plane.

2. A light detection system comprising:
a light detection unit including a plurality of photoelectric conversion portions arranged in a two-dimensional plane; and
a calculation processing unit configured to execute calculation based on information acquired by the light detection unit,
wherein the light detection unit acquires light amount distribution information of light based on an incident light beam incident on an object from a laser light source and light amount distribution information of light based on a refracting light beam refracted by the object in the two-dimensional plane,
wherein the calculation processing unit calculates, from the light amount distribution information of light based on the incident light beam, the light amount distribution information of light based on the refracting light beam, and time information about time at which the light amount distribution information of light based on the incident light beam and the light amount distribution information of light based on the refracting light beam are acquired, information about a normal vector with respect to a refracting plane of the object by which the incident light beam is refracted, and
wherein the normal vector is a vector in three dimensions including a direction orthogonal to the two-dimensional plane.

3. A light detection system comprising:
a light detection unit including a plurality of photoelectric conversion portions arranged in a two-dimensional plane; and
a calculation processing unit configured to execute calculation based on information acquired by the light detection unit,
wherein the light detection unit acquires light amount distribution information of light based on a reflected light beam emitted from a laser light source and reflected on an object in the two-dimensional plane,
wherein the calculation processing unit calculates, from direction information of laser light emitted to the object from the laser light source, the light amount distribution information of light based on the reflected light beam, and time information about time at which the light amount distribution information of light based on the reflected light beam is acquired, information about a normal vector with respect to a reflection plane of the object on which the laser light is reflected, and
wherein the normal vector is a vector in three dimensions which includes a direction orthogonal to the two-dimensional plane.

4. The light detection system according to claim 1, wherein a light emission timing of the laser light source and a detection timing of the light detection unit are controlled by a timing control unit.

5. The light detection system according to claim 1, wherein the photoelectric conversion portion is an avalanche diode.

6. The light detection system according to claim 1, further comprising a second light detection unit,
wherein the second light detection unit includes a plurality of second photoelectric conversion portions arranged in a two-dimensional plane, and
wherein the light detection unit and the second light detection unit are arranged at different positions.

7. The light detection system according to claim 1, wherein a light emission start operation of the laser light source and a light detection start operation of the photoelectric conversion portion are executed for a plurality of times in a state where a period from a start of light emission of the laser light source to a start of light detection of the photoelectric conversion portion is fixed.

8. The light detection system according to claim 1, wherein a period from a start of light emission of the laser light source to a start of light detection of the photoelectric conversion portion in a first frame period and a period from a start of light emission of the laser light source to a start of light detection of the photoelectric conversion portion in a second frame period are different from each other.

9. The light detection system according to claim 1, wherein the object is arranged outside a field of view of the light detection unit.

10. The light detection system according to claim 1, wherein the reflection plane for the laser light source is located in a blind area of the light detection unit.

11. The light detection system according to claim 1, further comprising a counter configured to count light incident on the photoelectric conversion portion,
wherein a control unit that controls a start of light detection of the photoelectric conversion portion is a switch or a logic circuit arranged at a position between the photoelectric conversion portion and the counter.

12. The light detection system according to claim 1, further comprising a counter configured to count light incident on the photoelectric conversion portion,
wherein a control unit that controls a start of light detection of the photoelectric conversion portion inputs to the counter a signal for shifting activation and non-activation of the counter.

13. The light detection system according to claim 1, wherein the light detection system calculates the plurality of normal vectors while changing a light emission position at which an incident light beam is emitted to the object from the laser light source, and estimates a shape of the object in a three-dimensional space from the plurality of normal vectors.

14. The light detection system according to claim 1, wherein the light based on the incident light beam and the light based on the reflected light beam are diffusion light.

15. The light detection system according to claim 2, wherein a light emission timing of the laser light source and a detection timing of the light detection unit are controlled by a timing control unit.

16. The light detection system according to claim 2, wherein the photoelectric conversion portion is an avalanche diode.

17. The light detection system according to claim 2, further comprising a second light detection unit,
wherein the second light detection unit includes a plurality of second photoelectric conversion portions arranged in a two-dimensional plane, and
wherein the light detection unit and the second light detection unit are arranged at different positions.

18. The light detection system according to claim 3, wherein a light emission timing of the laser light source and a detection timing of the light detection unit are controlled by a timing control unit.

19. The light detection system according to claim 3, wherein the photoelectric conversion portion is an avalanche diode.

20. The light detection system according to claim 3, further comprising a second light detection unit,
wherein the second light detection unit includes a plurality of second photoelectric conversion portions arranged in a two-dimensional plane, and
wherein the light detection unit and the second light detection unit are arranged at different positions.
